(19) United States
(12) Patent Application Publication
(10) Pub. No.: US 2017/0243261 A1
(43) Pub. Date: Aug. 24, 2017

(54) Efficient Pricing System with Product Interdependencies

(71) Applicant: Chicago Mercantile Exchange Inc., Chicago, IL (US)

(72) Inventors: Jennifer Weng, Brooklyn, NY (US); Panagiotis Xythalis, Scotch Plains, NJ (US); Yingwen Liu, Brooklyn, NY (US); Lingrui Xiang, Chicago, IL (US); Shuo Liu, London (GB); Sixiang Li, Chicago, IL (US); Chenda Huang, Hoboken, NJ (US); Ziyi Wang, Chicago, IL (US); Nataliya Frost, Glenview, IL (US); Xianqing Zou, Jersey City, NJ (US)

(21) Appl. No.: 15/052,409

(22) Filed: Feb. 24, 2016

(51) Int. Cl. G06Q 30/02; G06Q 40/04

(52) U.S. Cl. CPC G06Q 30/0283; G06Q 30/0206; G06Q 40/04

(57) ABSTRACT

Systems and methods are provided for efficiently determining prices of futures, spreads and swaps by considering product interdependencies. The disclosed systems and methods use interpolation, extrapolation and backward propagation to produce accurate results.

### FIELD OF THE INVENTION

Embodiments of the present invention relate to systems and methods for pricing of financial instruments. More particularly, the invention provides efficient systems and methods that determine prices of futures, spreads and swaps while considering product interdependencies.

### DESCRIPTION OF THE RELATED ART

Exchanges and other entities utilize computer systems to perform functions such as calculating values and prices for financial instruments, determining portfolio risks and determining initial and maintenance margin account requirements. Financial instruments can include futures, options, spreads, swaps and other combinations of financial instruments.

A futures or futures contract is a contract to buy or sell a particular commodity or financial instrument at a pre-determined price in the future. Futures contracts generally detail the quality and quantity of the underlying asset. They are generally standardized to facilitate trading on an exchange. Some futures contracts call for physical delivery while others call for cash settlement.

Options or options contracts may be used to hedge risks by allowing parties to agree on a sale price for a sale that will take place at a later time. One type of option is a call option. A call option gives the purchaser of the option the right, but not the obligation, to buy a particular asset at a later time at a guaranteed price. The guaranteed price is sometimes referred to as the strike or exercise price. Another type of option is a put option. A put option gives the purchaser of the option the right, but not the obligation, to sell a particular asset at a later time at the strike price. In either instance, the seller of the call or put option is obligated to perform the associated transactions if the purchaser chooses to exercise its option.

A swap is an agreement that a floating price is an average based on an underlying commodity future over a specific period. Most swaps include cash flows based on a notional amount. Each of the cash flows comprise a leg of the swap. An example of a swap includes a plain fixed-to-floating, or “vanilla,” interest rate swap. The vanilla swap includes an exchange of interest streams where one stream is based on a floating rate and the other interest stream is based on a fixed rate. In a vanilla swap, one party makes periodic interest payments to the other based on a variable interest rate. The variable rate may be linked to a periodically known or agreed upon rate for the term of the swap such as the London Interbank Offered Rate (LIBOR). Credit default swaps are also commonly traded financial instruments.

A composite or compo swap is an agreement that a floating price as an average based on an underlying commodity future with price converted from its currency to a different currency denominated for swap. For example, a leg linked to the performance of a stock or an equity basket/index may be settled in a first currency, while another leg, such as a financing leg, might be settled in a second currency. For instance, a composite swap may entail the receipt of an equity return denominated in dollar and the payment of financing leg denominated in Euro.

A spread product or position is a financial instrument where the price is a difference of leg 1 underlying price and leg 2 underlying price and may include two or more options, futures or other financial instruments. Spread products allow traders to profit through a change in the relative price relationships. Calendar spreads are examples of spread products. A calendar spread price is computed as the difference of an average of leg 1 underlying price and leg 2 underlying price. An example of a calendar spread includes buying an option to expire in October and selling an option on the same underlying asset expiring six months earlier.

Clearinghouses are structured to provide exchanges and other trading entities with solid financial footing. Maintaining proper margin amounts is an important part of maintaining solid financial footing. The required margin amount generally varies according to the volatility of a financial instrument; the more volatility, the larger the required margin amount. This is to ensure that the bond will cover maximum losses that a contract would likely incur over a given time period, such as a single day. Required margin amounts may be reduced where traders hold opposite positions in closely correlated markets or spread trades.

Exchanges and other entities utilize computer systems to perform functions such as calculating values and prices, determining portfolio risks and determining initial and maintenance margin account requirements. It is common for an exchange or other entity to utilize multiple computer systems to process data multiple times and with different computer devices. As the numbers of accounts and transactions increase, it becomes inefficient for exchanges and other entities to process data multiple times to determine values that may be related. In the trading environment the speed with which information can be determined and distributed to market participants can be critical. For example, regulations set time limits for clearing entities to provide margin requirements to market participants after the end of a trading day. Some market participants also expect clearing entities to quickly determine how a potential transaction will impact their margin.

Therefore there is a need in the art for more efficient computer systems and computer-implemented methods for calculating values and prices, determining portfolio risks and determining initial and maintenance margin account requirements.

### SUMMARY OF THE INVENTION

Embodiments of the present invention provide efficient computer systems and computer-implemented methods for determining prices of futures, spreads and swaps by considering product interdependencies. Some embodiments use interpolation, extrapolation and backward propagation to produce accurate results.

In various embodiments, the present invention can be partially or wholly implemented on a computer-readable medium, for example, by storing computer-executable instructions or modules, or by utilizing computer-readable data structures.

Of course, the methods and systems disclosed herein may also include other additional elements, steps, computer-executable instructions, or computer-readable data structures. The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention.

FIG. 2 illustrates a computer system that may be used to calculate values and prices for financial instruments, determine portfolio risks and/or determining initial and maintenance margin account requirements in accordance with an embodiment of the invention.

FIG. 3 illustrates a process that may be used to process data in accordance with an embodiment of the invention.

FIG. 4 illustrates how some energy related financial instruments are interdependent, in accordance with an embodiment of the invention.

FIG. 5 illustrates financial product relationships in the swap and spread space for energy related products.

FIG. 6 illustrates pricing relationships for financial products in the energy related space, in accordance with an embodiment of the invention.

FIG. 7 illustrates a method that applies aspects of the invention to daily composite swap financial instrument pricing, in accordance with an embodiment of the invention.

FIG. 8 illustrates a method of extrapolating a seasonal product forward curve in accordance with an embodiment of the invention.

FIG. 9 illustrates a process for using backward propagation to complete an underlying forward curve in accordance with an embodiment of the invention.

FIG. 10 illustrates a process that may be used to generate future marker prices, in accordance with an embodiment of the invention.

### DETAILED DESCRIPTION OF THE INVENTION

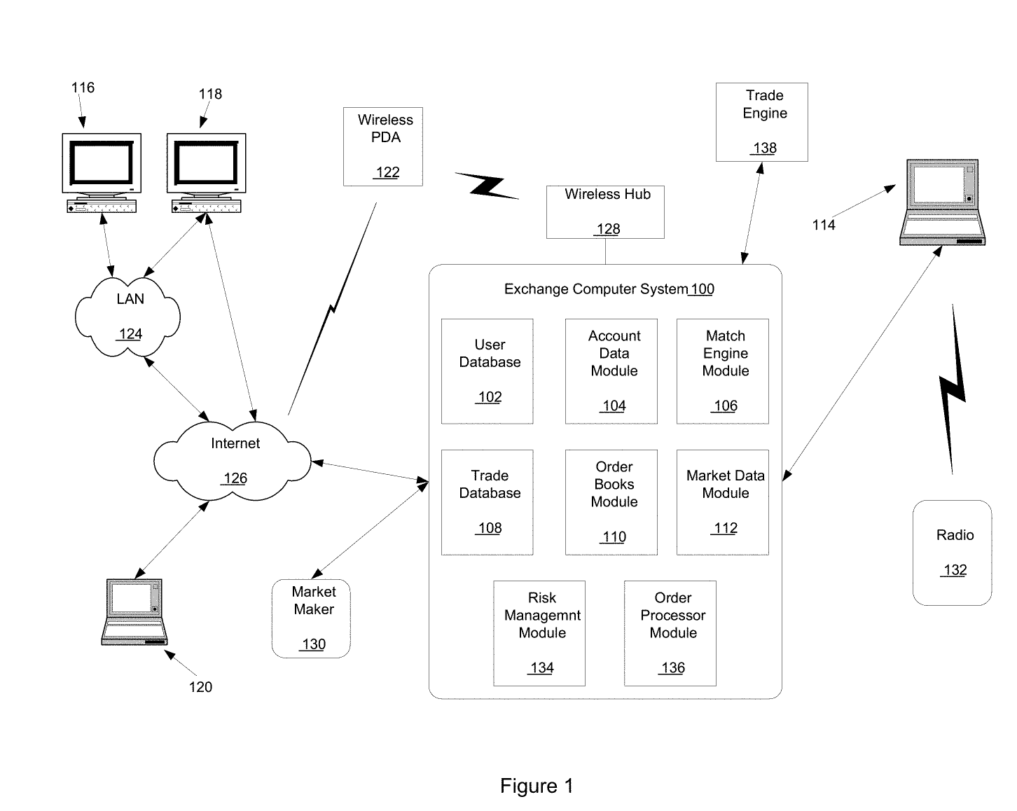

Aspects of the present invention may be implemented with computer devices and computer networks that allow users to exchange trading information. An exemplary trading network environment for implementing trading systems and methods is shown in FIG. 1.

An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

In one alternative embodiment, a clearinghouse computer or computer system may be included. A clearinghouse or other entity that clears trades may use a clearinghouse computer or computer system to accurately calculate swaption settlement prices, values, risk and margin requirements.

Various embodiments of the invention use computer systems to perform functions such as calculating values and prices for financial instruments, determining portfolio risks and determining initial and maintenance margin account requirements. The financial instruments involved include futures, options, spreads, swaps and other combinations of financial instruments. As part of the process of validating data that is determined, historical data is analyzed to determine product interdependencies.

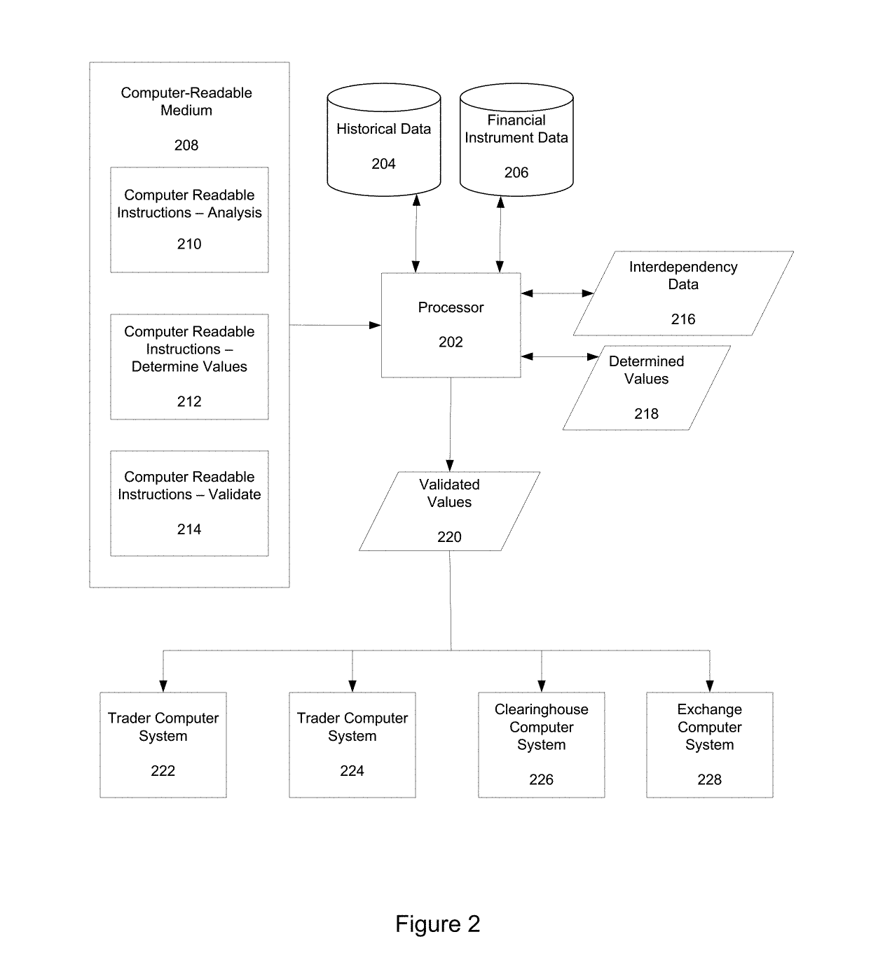

FIG. 2 illustrates a computer system that may be used to calculate values and prices for financial instruments, determine portfolio risks and/or determining initial and maintenance margin account requirements in accordance with an embodiment of the invention. A processor 202 may be included to control the operation of the computer system. Processor 202 may be implemented with a microprocessor or other hardware device. A historical database 204 may be included to store historical trade data and a financial instrument database 206 may be included to store financial instrument data. In some embodiments, financial instrument database 206 includes financial instrument term sheets. Databases 204 and 206 may be implemented with hardware, such as memory devices.

Processor 202 may be connected to a computer-readable medium 208. Computer-readable medium 208 may be implemented with a solid state memory, physical memory or some other memory device. Computer-readable memory 208 may store computer-executable instructions for controlling the operation of processor 202. For example, computer-readable memory 208 may include computer-executable instructions 210 for causing processor 202 to analyze financial instrument data received from financial instrument database 206 to generate interdependency data 216. Computer-readable memory 208 may also include computer-executable instructions 212 for causing processor 202 to determine values such as prices, risk parameters and margin requirements. Processor 202 may use computer-executable instructions 212 to generate determined values 218. Computer-readable memory 208 may include computer-executable instructions 214 for causing processor 202 to validate determined values 218 to generate validated values 220. Examples of processes used to validate data are described below.

Validated values 220 may be transmitted to a variety of other computer systems. For example, validated values 220 may be sent to trader computer systems 222 and 224. Trader computer systems 222 and 224 may use the validated values 220 to make trading decisions. Validated values 220 may also be used by a clearinghouse computer system 226 to determine margin account requirements. One or more exchange computer systems, such as exchange computer system 228 or exchange computer system 100 (shown in FIG. 1) may also receive validated values 220.

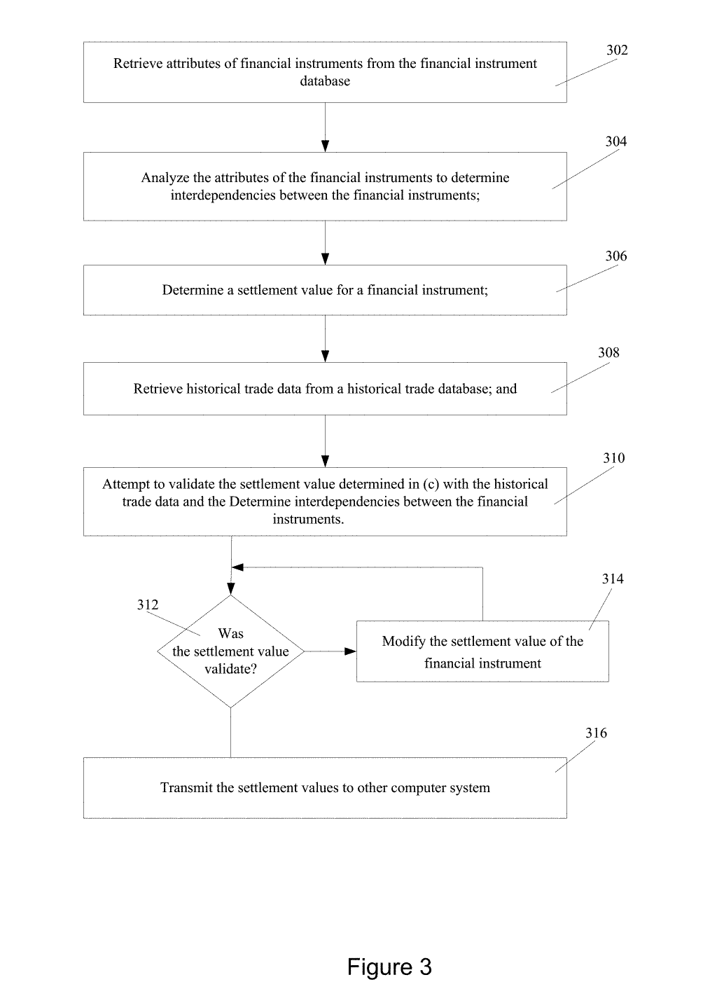

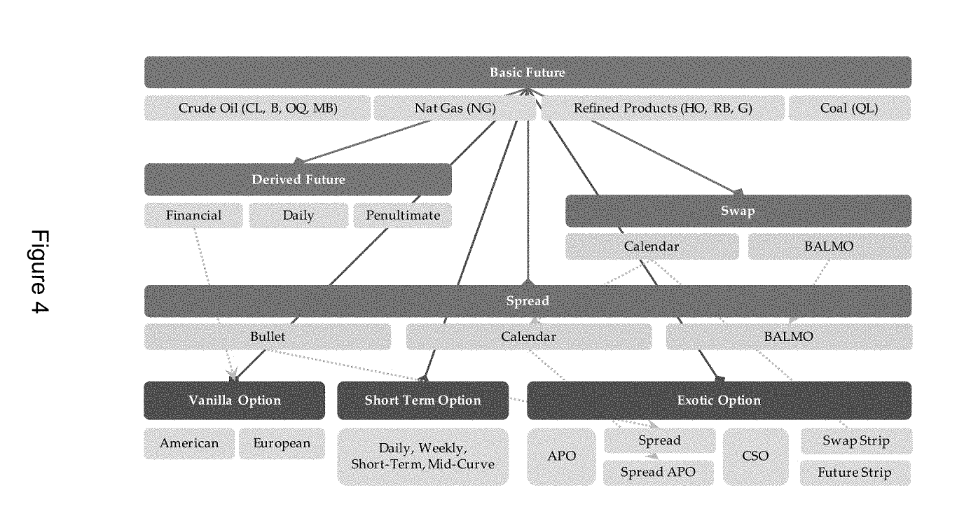

FIG. 3 illustrates a process that may be used to process data in accordance with an embodiment of the invention. In some embodiments, some parts of or all of the process shown in FIG. 3 may be implemented with the computer system shown in FIG. 2. First, in step 302 attributes of financial instruments are retrieved from a financial instrument database. In alternative embodiments attributes are retrieved from one or more alternative sources.

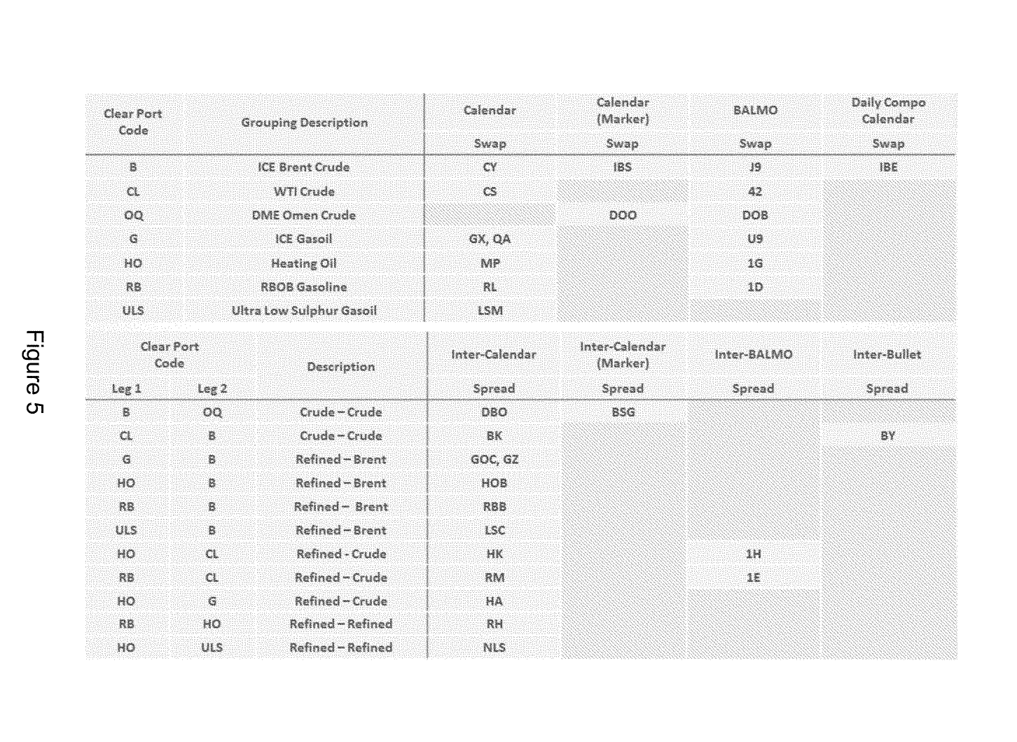

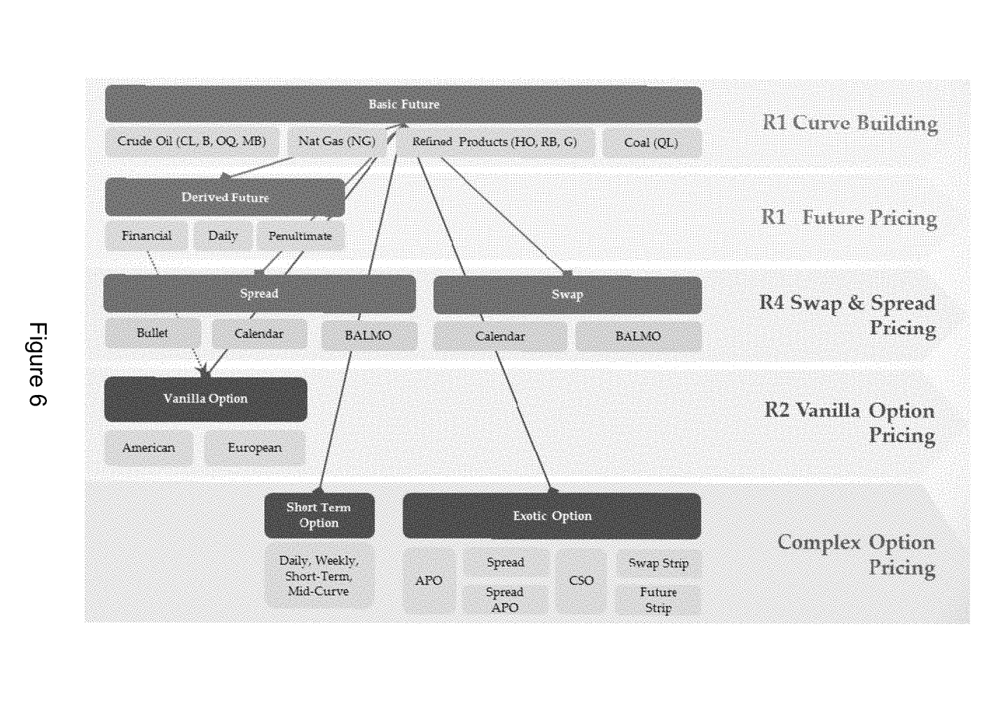

Next, the attributes of the financial instruments are analyzed in step 304 to determine interdependencies between the financial instruments. FIGS. 4, 5 and 6 show relationships between exemplary financial instruments. FIG. 4 illustrates how some energy related financial instruments are interdependent, in accordance with an embodiment of the invention. The interdependencies of financial instruments may be determined by analyzing attributes that are included in term sheets that describe the financial products. FIG. 5 illustrates financial product relationships in the swap and spread space for energy related products. FIG. 6 illustrates pricing relationships for financial products in the energy related space, in accordance with an embodiment of the invention.

In step 306 a settlement value for a financial instrument is determined. Step 306 may include using a conventional process to determine a settlement value. Alternative embodiments of the invention may include determining additional and/or alternative values such as other prices, risk parameters or other values generally used in trading environments.

Historical trade data may be retrieved from a historical trade database or other source in step 308. Next, in step 310 an attempt is made to validate the settlement value, or other value(s), determined in step 306 with the historical trade data and the determined interdependencies between the financial instruments. Step 310 may include determining if the settlement value or other value(s) are consistent with determined interdependencies between the financial instruments.

In step 312 it is determined whether the settlement value or other value(s) are validated. If there is no validation, in step 314 the settlement value of the financial instrument or other value(s) are modified so that they are validated. After the settlement value or other value(s) are validated, in step 316, the validated values may be transmitted to another computer system, such as a clearinghouse computer system.

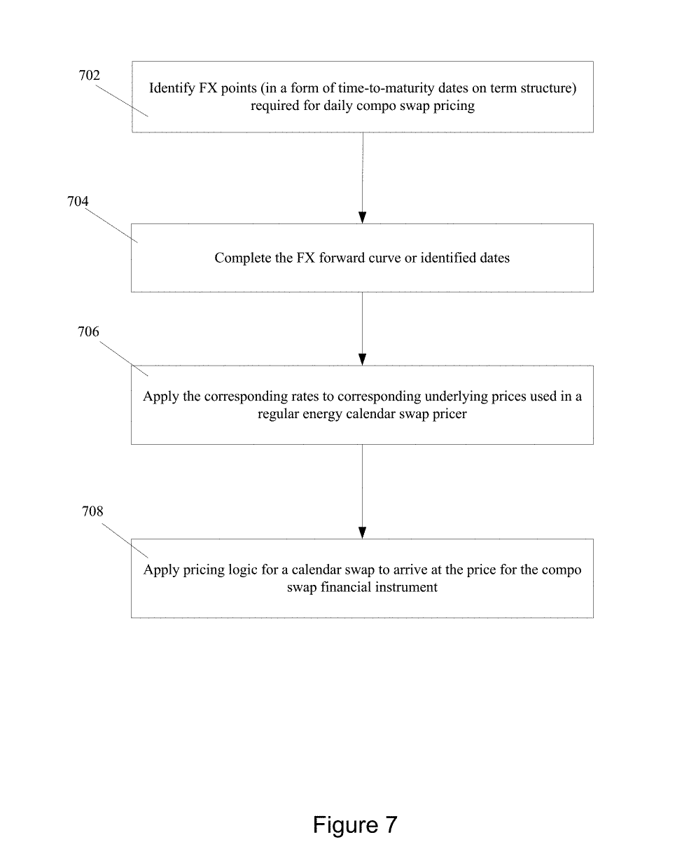

FIG. 7 illustrates a method that applies aspects of the invention to daily composite swap financial instrument pricing, in accordance with an embodiment of the invention. The process shown in FIG. 7 allows computer system to operate efficiently by utilizing a constructed FX forward curve and incorporating the data into the pricing of energy related financial instruments. First, in step 702, FX points required for daily compo swap pricing are identified. The FX points may be in a form of time-to-maturity dates on term structure. Next, the FX forward curve is completed for identified dates in step 704. Step 704 may include using linear interpolation or other interpolation of curve fitting techniques. The corresponding rates are then applied to corresponding underlying prices used in a regular energy calendar swap pricer in step 706. Finally, in step 708 pricing logic for a calendar swap is applied to arrive at the price for the compo swap financial instrument.

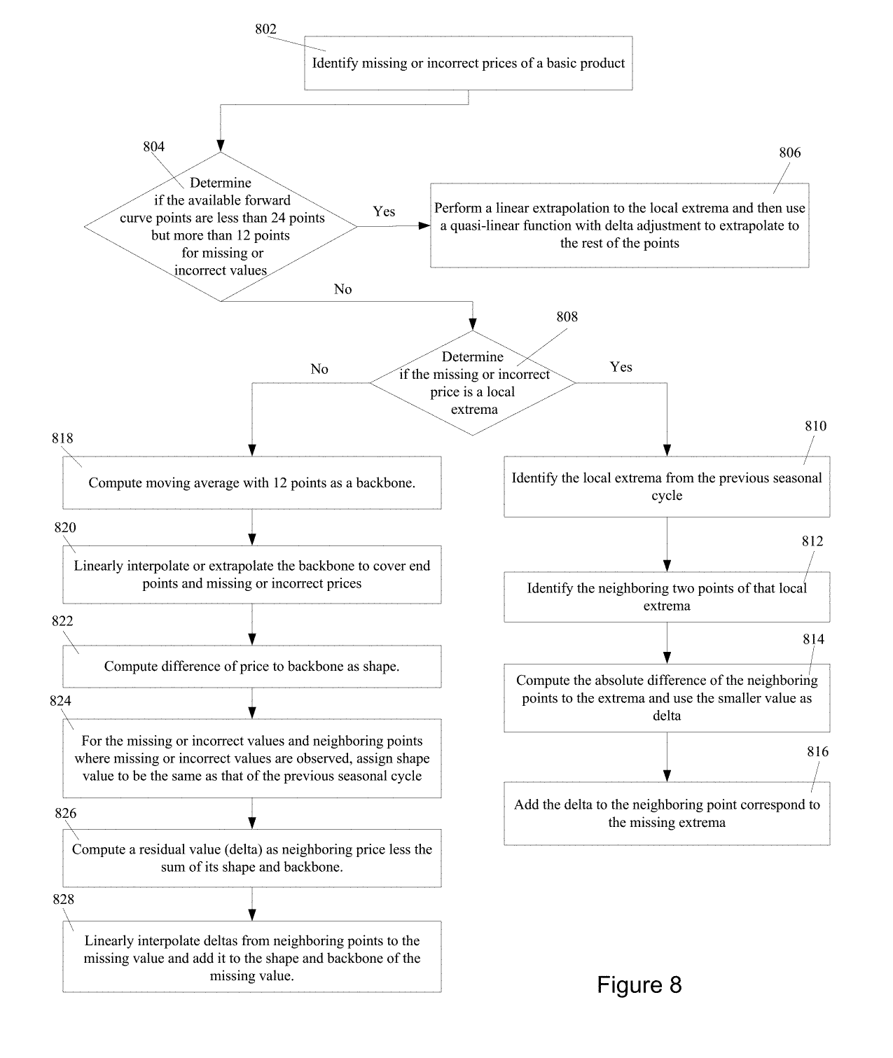

Aspects of the invention may also be used to extrapolate a seasonal product forward curve. FIG. 8 illustrates a method of extrapolating a seasonal product forward curve in accordance with an embodiment of the invention. First in step 802 a missing or incorrect price of a basic product is identified. For example, for a given futures, x number of contracts are tradable at a given date; but there may only be y number of contracts being actually traded. Therefore, there are x-y number of contracts that does not have an actual market trade price and hence settlement price. In this case some prices are missing where risk framework (that operates on the complete price curves) requires validate and fill in the prices. Historical pricing data may be used to identify incorrect prices. Next, in step 804 it is determined if the available forward curve points are less than 24 points but more than 12 points for missing or incorrect values. If they are, in step 806 a linear extrapolation to the local extrema is performed and then a quasi-linear function with delta adjustment to extrapolate to the rest of the points may be used. If they are not, the process moves to step 808 were it is determined if the missing or incorrect price is a local extrema.

If it is determined in step 808 that the missing or incorrect price is a local extrema, a local extrema interpolation may be performed beginning in step 810. In step 810, a local extrema from the previous seasonal cycle is identified. Step 810 may include analyzing historical data. Next, in step 812, the neighboring two points of the local extrema are identified. In step 814, the absolute difference of the neighboring points to the extrema is commuted and the smaller value is used as delta. Finally, in step 816 the delta is added to the neighboring point corresponds to the missing or incorrect extrema.

If it is determined in step 808 that the missing or incorrect price is not a local extrema, a regular interpolation may be performed beginning in step 818. In step 818 a moving average with 12 points is computed as a backbone. In other embodiments, fewer or more than 12 points may be used to compute a backbone. Next, in step 820 the backbone may be interpolated or extrapolated to cover end points and missing or incorrect prices. In some embodiments liner interpolation is used. In step 822, a difference of price to backbone may be computed as a shape. Next, in step 824 for the missing or incorrect values and neighboring points where missing or incorrect values are observed, the shape value is assigned to be the same as that of the previous seasonal cycle. A residual value (delta) is computed as a neighboring price less the sum of its shape and backbone in step 826. In step 828, interpolation of deltas from neighboring points to the missing or incorrect value may be used and added to the shape and backbone of the missing value.

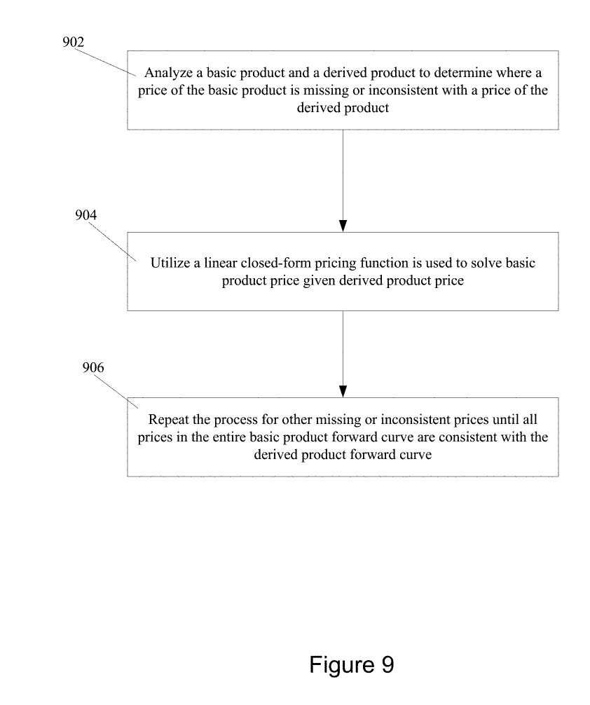

FIG. 9 illustrates a process for using backward propagation to complete an underlying forward curve in accordance with an embodiment of the invention. First, a basic product and a derived product are analyzed to determine where a price of the basic product is missing or inconsistent with a price of the derived product in step 902. Next, a linear closed-form pricing function is used to solve basic product price given derived product price in step 904. Alternative embodiments of the invention may use other functions to determine a basic product price in view of a derived product price. In step 906 the process is repeated for other missing or inconsistent prices until all prices in the entire basic product forward curve are consistent with the derived product forward curve.

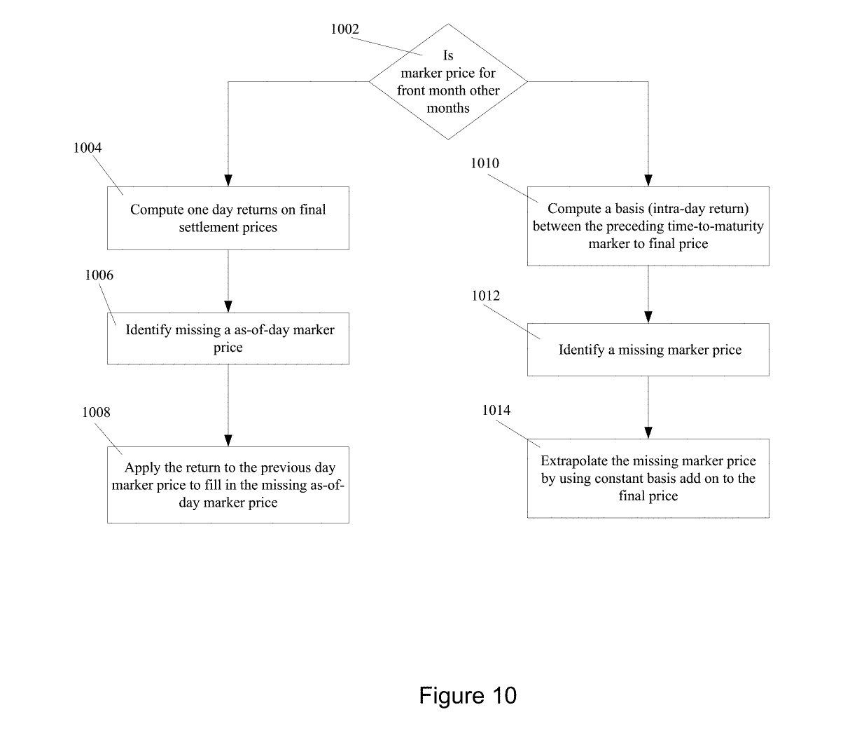

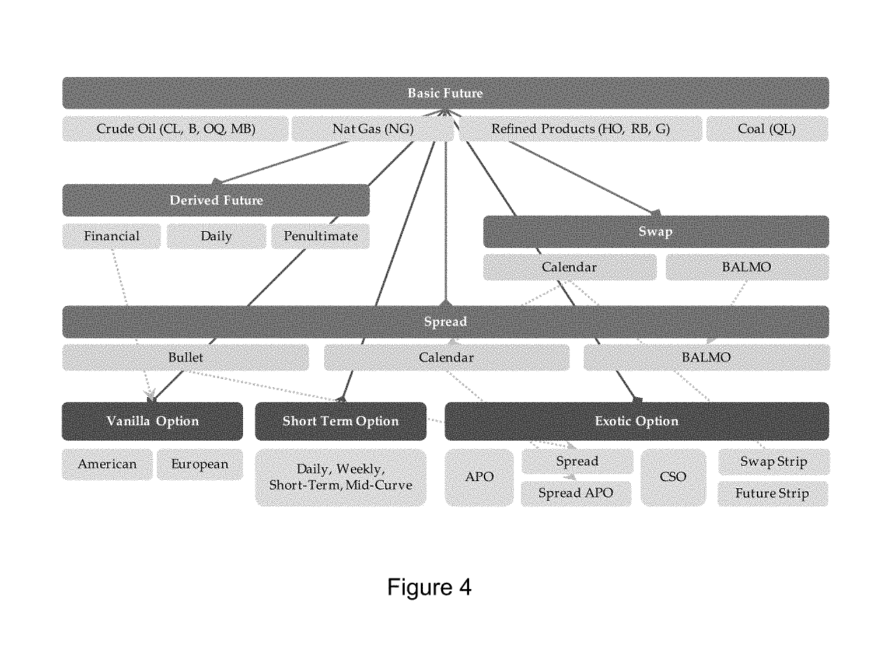

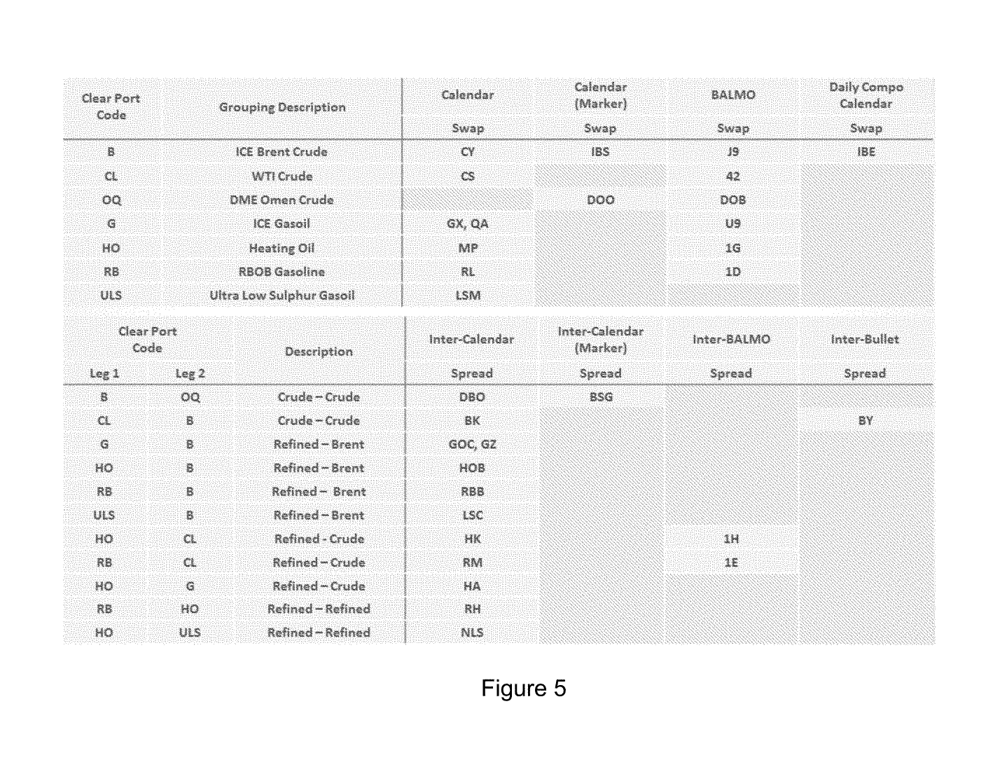

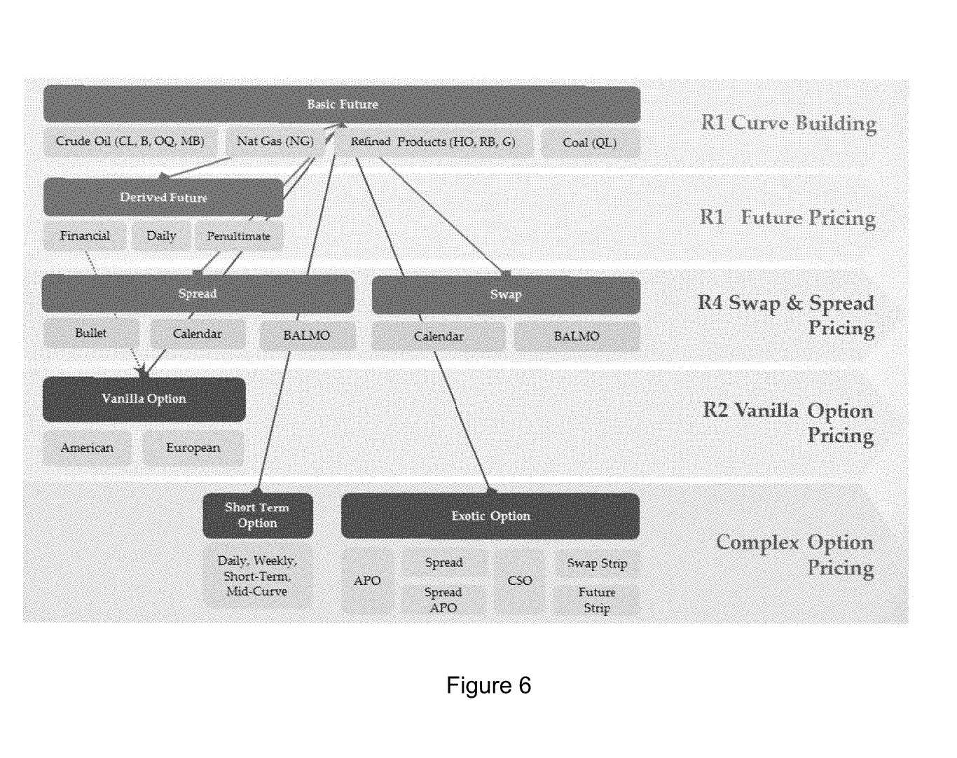

FIG. 10 illustrates a process that may be used to generate future marker prices, in accordance with an embodiment of the invention. First, in step 1002 it is determined whether a marker price is a front month marker price or a price for other months. When the price is a front month marker price, in step 1004 one day returns on final settlement prices are computed. In step 1006, a missing as-of-day marker price is identified. And, in step 1008 the return to the previous day marker price is applied to fill in the missing as-of-day marker price. When the price is for other months, in step 1010 a basis (intra-day return) between the preceding time-to-maturity marker to final price is computed. Next, in step 1012 a missing marker price is identified. Finally, in step 1014 the missing marker price is extrapolated by using constant basis add on to the final price.

Those skilled in the art will appreciate that interdependencies between other financial instruments may also be determined by analyzing attributes included in term sheets or other sources. Various algorithms may also be used to identify interdependencies between financial instruments.

The disclosed computer systems, such as exchange computer 100 and the computer system shown in FIG. 2 have limited processing capabilities. Some computer-implemented algorithms may use interpolation, data filtering or other steps to allow a computer device programmed with one of the computer-implemented algorithms to efficiently and quickly determine and communicate pricing, volatility and margin requirements.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. For example, various methods are disclosed herein with steps that are performed in exemplary orders. In alternative embodiments the steps may be performed in other orders without departing from the broader spirit and scope of the invention. All variations and alternative embodiments are considered within the sphere, spirit, and scope of the invention.

1. A computer system comprising:
a financial instrument database that stores attributes of financial instruments;
a processor;
a tangible computer-readable medium containing computer executable instructions that when executed by the processor cause the computer system to perform the steps comprising:
(a) retrieving attributes of financial instruments from the financial instrument database;
(b) analyzing the attributes of the financial instruments to determine interdependencies between the financial instruments;
(c) determining a settlement value for a financial instrument;
(d) retrieving historical trade data from a historical trade database; and
(e) attempting to validate the settlement value determined in (c) with the historical trade data and the determined interdependencies between the financial instruments.

2. The computer system of claim 1, wherein the financial instrument database includes data from term sheets of financial instruments.

3. The computer system of claim 1, wherein (b) comprises determining interdependencies between futures and spread financial instruments.

4. The computer system of claim 1, wherein (b) comprises determining interdependencies between futures and swap financial instruments.

5. The computer system of claim 1, wherein (b) comprises determining interdependencies between futures and options financial instruments.

6. The computer system of claim 1, wherein (c) comprises determining a settlement value for a composite swap financial instrument.

7. The computer system of claim 1, wherein the tangible computer-readable medium contains further computer executable instructions that when executed by the processor cause the computer system to perform the steps comprising:
(f) modifying the settlement value of the financial instrument so that the settlement value is validated in step (e).

8. The computer system of claim 1, further including a clearinghouse computer system and wherein the tangible computer-readable medium contains further computer executable instructions that when executed by the processor cause the computer system to transmit the settlement value to the clearinghouse computer system.

9. The computer system of claim 8, wherein the clearinghouse computer system includes a processor programmed with computer-executable instructions to determine a margin requirement.

10. The computer system of claim 8, wherein the clearinghouse computer system includes a processor programmed with computer-executable instructions to determine a risk parameter.

11. The computer system of claim 1, wherein the tangible computer-readable medium contains further computer executable instructions that when executed by the processor cause the computer system to transmit the settlement value to a trader computer system.

12. A computer system comprising:
a financial instrument database that stores attributes of financial instruments;
a processor;
a tangible computer-readable medium containing computer executable instructions that when executed by the processor cause the computer system to perform the steps comprising:
(a) analyze a basic product and a derived product to determine where a price of the basic product is missing or inconsistent with a price of the derived product;
(b) utilize a linear closed-form pricing function to solve basic product price given derived product price; and
(c) repeat (a) and (b) for other missing or inconsistent prices until all prices in a basic product forward curve are consistent with the derived product forward curve.

13. The computer system of claim 12, wherein the basic product is an energy related financial instrument.

14. The computer system of claim 13, wherein the compo swap financial instrument comprises an oil related financial instrument.

15. The computer system of claim 12, wherein the tangible computer-readable medium contains further computer executable instructions that when executed by the processor cause the computer system to perform the steps comprising:
(d) determining a settlement value.

16. The computer system of claim 12, wherein the tangible computer-readable medium contains further computer executable instructions that when executed by the processor cause the computer system to perform the steps comprising:
(e) determining a margin requirement.

17. A computer system comprising:
a financial instrument database that stores attributes of financial instruments;
a processor;
a tangible computer-readable medium containing computer executable instructions that when executed by the processor cause the computer system to perform the steps comprising:
(a) identify FX points required for daily compo swap pricing;
(b) complete an FX forward curve for identified dates;
(c) apply corresponding rates to corresponding underlying prices used in a regular energy calendar swap pricer; and
(d) apply pricing logic for a calendar swap to arrive at the price for the compo swap financial instrument.

18. The computer system of claim 17, wherein the compo swap financial instrument comprises an energy related financial instrument.

19. The computer system of claim 17, wherein the compo swap financial instrument comprises an oil related financial instrument.

20. The computer system of claim 17, further including a clearinghouse computer system and wherein the tangible computer-readable medium contains further computer executable instructions that when executed by the processor cause the computer system to data the clearinghouse computer system.
